(19) United States
(12) Patent Application Publication
(10) Pub. No.: US 2023/0016348 A1
(43) Pub. Date: Jan. 19, 2023

(54) METHOD AND SYSTEM FOR DETECTING FISH SCHOOL HUNGER DEGREE BASED ON FEEDING BEHAVIOR

(71) Applicant: Wuhan University, Wuhan (CN)

(72) Inventors: Zongyao SHA, Wuhan (CN); Chunfang WANG, Wuhan (CN)

(21) Appl. No.: 17/865,429

(22) Filed: Jul. 15, 2022

(30) Foreign Application Priority Data
Jul. 16, 2021 (CN) 202110804092.9

(51) Int. Cl. A01K 61/80; A01K 61/60

(52) U.S. Cl. CPC A01K 61/80; A01K 61/60

(57) ABSTRACT

A method for detecting fish school hunger degree based on feeding behavior includes: detecting a water wave fluctuation driven by the feeding of a fish school using a water surface floating body; controlling a fish feeder by calculating water wave fluctuation intensity. The water wave fluctuation is detected by adopting a detection device associated with the water surface floating body.

### CROSS-REFERENCE TO RELATED APPLICATIONS

Pursuant to 35 U.S.C.§ 119 and the Paris Convention Treaty, this application claims foreign priority to Chinese Patent Application No. 202110804092.9 filed on Jul. 16, 2021, the contents of which, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, MA 02142.

### BACKGROUND

The disclosure relates to the field of intelligent fishery, and more particularly to a method and system for real-time hunger degree detection for fish school and thus precise feeder control.

Intelligent fish feeding requires accurate and real-time feedback from fish behavior. How to decide the exact time to close a fish feeder according to the hunger degree of fish or culture objects is important to precisely allocate the suitable number of feeds as needed, which not only cuts feed cost but also minimizes water pollutants.

### SUMMARY

The disclosure provides a method for detecting fish school hunger degree based on feeding behavior, the method comprising: detecting a water wave fluctuation driven by the feeding of a fish school using a water surface floating body; controlling a fish feeder by calculating water wave fluctuation intensity, the water wave fluctuation being detected by adopting a detection device associated with the water surface floating body.

In a class of this embodiment, to detect the movement of the water surface floating body, an infrared detection device or other methods capable of detecting a frequency or amplitude of the movement of the water surface floating body are adopted.

In a class of this embodiment, the infrared detection device comprises an infrared radiation tube and a retro-reflective sensor;

a transmitting end and a receiving end of the infrared radiation tube are disposed perpendicular to a horizontal plane; after the transmitting end of the infrared radiation tube transmits an infrared signal, if no oblique fluctuation occurs, the infrared signal is capable of being received by the corresponding receiving end, and if an oblique displacement occurs, the infrared signal is not capable of being received by the corresponding receiving end; and

the retro-reflective sensor includes a signal transmitting/receiving end and a signal reflector; the signal transmitting/receiving end and the signal reflector are disposed parallel to the horizontal plane; after the signal transmitting/receiving end of the retro-reflective sensor transmits an infrared signal, if no upward and downward fluctuation occurs, the infrared signal is capable of being reflected back by the signal reflector and received, and if an upward and down displacement occurs, the infrared signal is not capable of being reflected back and no signal is capable of being received.

In a class of this embodiment, a signal transmitting end fixing rod is disposed to connect the water surface floating body, the receiving end of the infrared radiation tube and the signal transmitting/receiving end of the retro-reflective sensor; the water surface floating body is connected to a bottom of the signal transmitting end fixing rod, the receiving end of the infrared radiation tube is disposed at a top of the signal transmitting end fixing rod, and the signal transmitting/receiving end of the retro-reflective sensor is disposed at a middle position of the signal transmitting end fixing rod.

In a class of this embodiment, a single-chip microcomputer is disposed to receive detection results of the infrared radiation tube and the retro-reflective sensor, and calculate the water wave fluctuation intensity.

In a class of this embodiment, the water wave fluctuation is calculated through a movement average value or maximum value of a preset time window.

In a class of this embodiment, the water surface floating body is made of plastic foam or floating materials.

In a class of this embodiment, the water surface floating body has a shape of a sphere, an ellipsoid or a flat plate and has a circular vertical projection on a water surface from top to bottom.

In another aspect, the disclosure further provides a system for detecting fish school hunger degree based on feeding behavior, providing a method for detecting fish school hunger degree based on feeding behavior.

In a class of this embodiment, the system comprises a power supply battery, an infrared radiation tube, a retro-reflective sensor, a water surface floating body, a signal transmitting end fixing rod, a protection cover, a cover fixing support, and a single-chip microcomputer;

the power supply battery supplies power to the infrared radiation tube, the retro-reflective sensor and the single-chip microcomputer;

a transmitting end and a receiving end of the infrared radiation tube are disposed perpendicular to a horizontal plane; after the transmitting end of the infrared radiation tube transmits an infrared signal, if no oblique fluctuation occurs, the infrared signal is capable of being received by the corresponding receiving end, and if an oblique displacement occurs, the infrared signal is not capable of being received by the corresponding receiving end; and

the retro-reflective sensor includes a signal transmitting/receiving end and a signal reflector; the signal transmitting/receiving end and the signal reflector are disposed parallel to the horizontal plane; after the signal transmitting/receiving end of the retro-reflective sensor transmits an infrared signal, if no upward and downward fluctuation occurs, the infrared signal is capable of being reflected back by the signal reflector and received, and if an upward and down displacement occurs, the infrared signal is not capable of being reflected back and no signal is capable of being received;

the signal transmitting end fixing rod is connected to the water surface floating body, the receiving end of the infrared radiation tube and the signal transmitting/receiving end of the retro-reflective sensor; the water surface floating body is connected to a bottom of the signal transmitting end fixing rod, the receiving end of the infrared radiation tube is disposed at a top of the signal transmitting end fixing rod, and the signal transmitting/receiving end of the retro-reflective sensor is disposed at a middle position of the signal transmitting end fixing rod;

the protection cover is disposed vertically, a bottom end of the protection cover is even with the horizontal plane, the cover fixing support is connected to the protection cover, and the single-chip microcomputer receives signals of the infrared radiation tube and the retro-reflective sensor, calculates a water wave change frequency of the water surface floating body, determines an activity of the feeding behavior of the fish school according to the frequency, and sends an instruction of feeding continuation or feeding stopping to the fish feeder.

The disclosure is used for accurately controlling the start of a fish feeder in the intelligent fishery. When the fish school are hungry, a feeding process shows a competition process, resulting in obvious water surface fluctuation and increasing the frequency of water wave fluctuation. A water surface floating body may be used for detecting the leftward, rightward, upward and downward movement of water waves. Then, some signal receiving and processing elements, such as infrared radiation or reflection methods, may be used. When the water surface floating body moves left and right as well as up and down due to water wave fluctuation, as a result, a signal transmitted by an infrared transmitting end is not capable of being effectively detected by a receiving end, indicating that the feeding behavior of the fish school is obvious, so a controller will send an instruction of continuously feeding feed. On the contrary, when the fish school are not interested in feeding after they are full and the water surface floating body movement frequency is low, most of the transmitted infrared signals can be received normally, so the controller will send an instruction of stopping the feeder. The disclosure can control the feeding of the feeder according to the hunger degree of the culture objects, and plays an important role in reducing the feed cost and controlling the water environment quality.

The solution of the disclosure is simple and convenient to implement, has strong practicability, solves the problems of low practicability and inconvenient practical application of related arts, can improve user experience, and has an important market value.

### BRIEF DESCRIPTION OF THE DRAWINGS

FIG. 1 is a schematic diagram of basic components of a device according to an embodiment of the disclosure;

FIG. 2 is a schematic diagram of different movement states of a water surface floating body (sphere) in an embodiment of the disclosure;

FIG. 3 is a schematic diagram of different movement states of a water surface floating body (floating plate) in an embodiment of the disclosure;

FIG. 4 is a schematic diagram of signal receiving and control under different states of a water surface floating body in an embodiment of the disclosure; and

FIG. 5 is a schematic diagram of signal loss frequency-time change (sum of transverse and longitudinal signal frequency loss, average) according to an embodiment of the disclosure.

### DETAILED DESCRIPTION

The technical solution of the disclosure will be described below in detail in combination with the embodiments with reference to the drawings.

The disclosure proposes that a water surface floating body is used for sensing water wave fluctuation intensity driven by feeding of a fish school, and a fish feeder is controlled by calculating the water wave fluctuation intensity.

In the specific implementation, the water wave fluctuation is detected through a detection device associated with the water surface floating body. For example, a special detection device connected to the water surface floating body or placed inside the water surface floating body, including but not limited to infrared detection methods, may be adopted.

The water wave fluctuation may be calculated through a movement average value of different time windows. For example, if a 30 second movement window is adopted, it should be generally selected between 10 seconds and 1 minute, and an empirical value obtained from previous experiments may be adopted. The water wave fluctuation intensity is used for driving the switching action of the fish feeder.

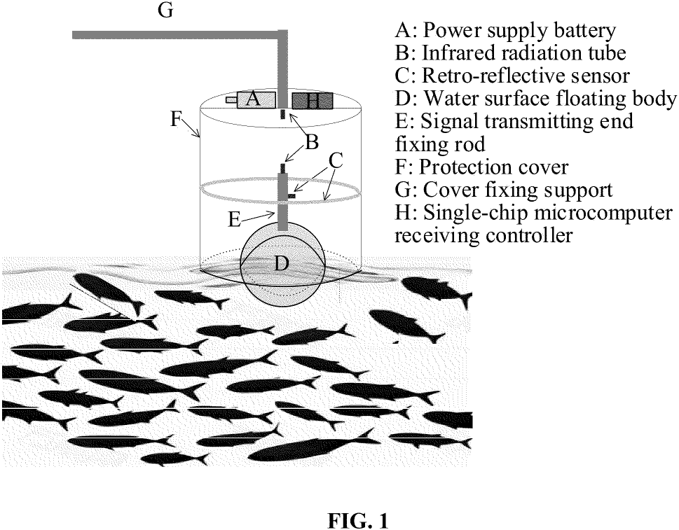

A system for detecting fish school hunger degree based on feeding behavior provided by an embodiment of the disclosure includes components A to H as illustrated in FIG. 1.

A power supply battery A provides a power support for the whole system and supplies power to the following components B, C and H.

An infrared radiation tube B includes a group of infrared transmitting and receiving devices. A transmitting end is disposed at a top of a protection cover F. A receiving end is disposed below and perpendicular to a horizontal plane. After the transmitting end of the infrared radiation tube transmits an infrared signal, if no oblique fluctuation occurs, the infrared signal is capable of being received by the corresponding receiving end, and if an oblique displacement occurs, the infrared signal is not capable of being received by the corresponding receiving end.

A retro-reflective sensor C includes a signal transmitting (receiving) end and a signal reflector. The retro-reflective sensor C is generally realized through infrared detection, but the signal transmitting and receiving ends of C are integrated. This signal transmitting (receiving) end is usually recorded as signal transmitting/receiving end according to the industry custom. The signal transmitting (receiving) end and the signal reflector are disposed parallel to the horizontal plane. The signal reflector may be disposed on an inner wall of a side of the protection cover F. After the signal transmitting (receiving) end of the retro-reflective sensor C transmits an infrared signal, if no upward and downward fluctuation occurs, the infrared signal is capable of being reflected back by the signal reflector and received, and if an upward and downward displacement occurs, the infrared signal is not capable of being reflected back and no signal is capable of being received.

A water surface floating body D senses a change of water waves and transmits the change to B and C.

A signal transmitting end fixing rod E is connected to the receiving devices of D and B and the signal transmitting (receiving) end of C. Its height relative to the water surface may be adjusted, so that the signal transmitting (receiving) end of the retro-reflective sensor C and the signal reflector are in the same horizontal plane (the initial state when the water surface does not fluctuate). The water surface floating body D is connected to a bottom of the signal transmitting end fixing rod E. The receiving end of the infrared radiation tube B is disposed at a top of the signal transmitting end fixing rod E. The signal transmitting (receiving) end of the retro-reflective sensor C is disposed at a middle position of the signal transmitting end fixing rod E. Therefore, the disclosure adopts retro-reflective infrared detection (realized by C) and infrared radiation (realized by B) respectively from longitudinal upward and downward displacement and transverse swing displacement directions of water waves to capture the change of the water waves, calculate the fluctuation intensity and indicate the hunger degree of the fish school. A protection cover F is preferably a cylinder and is disposed vertically. A bottom end of the protection cover is even with the horizontal plane. The protection cover is used for preventing rain and provide the fixation of components such as batteries. At the same time, it can also ensure that the water surface floating body D will not drift outside a feed feeding area. A cover fixing support G may adopt an extension rod fixed on the pond/culture pool or the bank to connect the protection cover F and play a role in fixing the whole device. A single-chip microcomputer receiving controller H receives the signals ofB and C, calculates the water wave change frequency of D, and determines the activity of feeding behavior of the fish school according to the frequency, so as to send an instruction of feeding continuation or feeding stopping to the fish feeder. In the specific implementation, the single-chip microcomputer receiving controller H can be realized by using an existing single chip-microcomputer chip product, so it is often referred to as single-chip microcomputer, which will not be repetitively described in the disclosure.

The water surface floating body D may float on the water surface, and its shape, size and density have a certain impact on the transmission of the water waves and the feeding activity of the fish school. Preferably, plastic foam or any floating material may be used. Its shape, size and density may be set according to the situation. In terms of shape, preferably it is suggested that it be a sphere, flattened ellipsoid or circular plate. When viewed from top to bottom, an observed projection is circular or nearly circular, and its contact area with the water surface determines its response to the activity of the fish school. When the density of the fish school is relatively large, the water surface floating body D may be smaller. On the contrary, it should be larger. The circular or nearly circular projection surface on the water surface may be between 5 cm and 50 cm. When the individual of the fish school is large, its density may be low. Otherwise, it may be high.

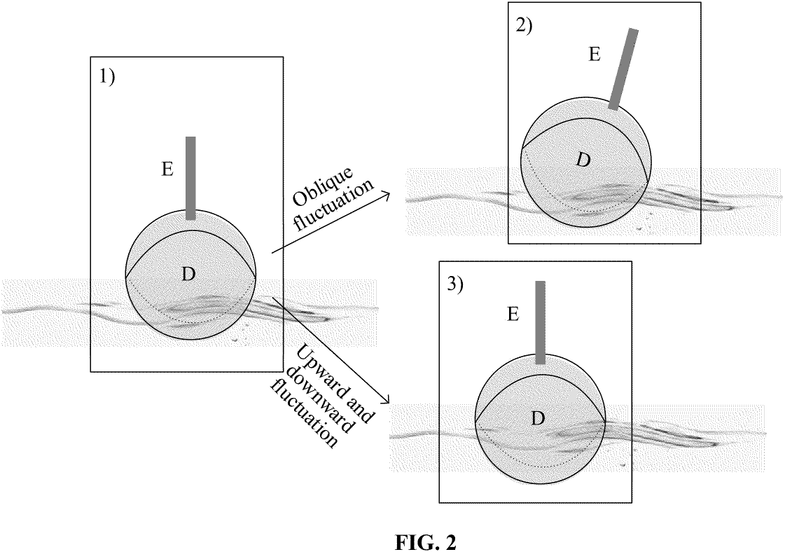

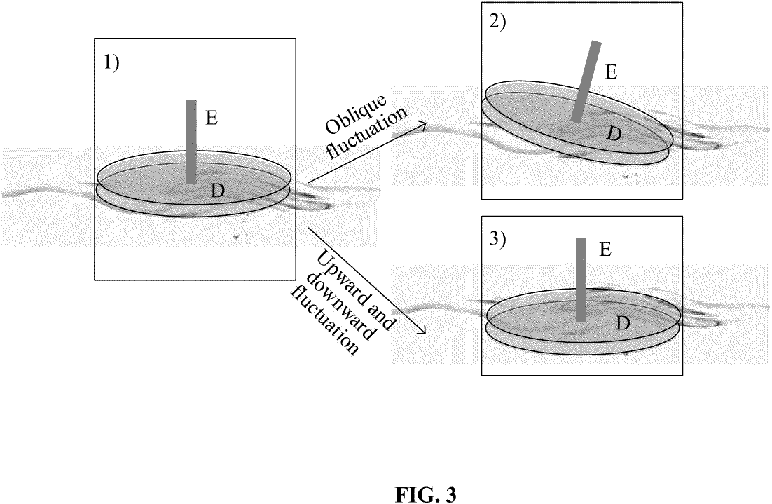

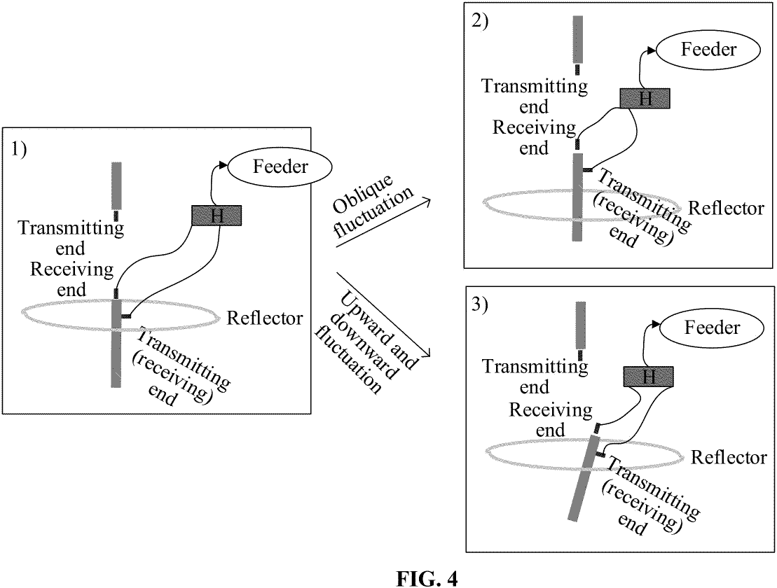

FIG. 2 and FIG. 3 respectively illustrate that D adopts a sphere and a circular plate. When no fish feeding occurs normally, the water surface floating body is in a state illustrated in 1) in FIG. 2 and FIG. 3. At this time, the water surface floating body feels a calm water surface, and the water surface floating body is in an upright state. When fish feeding occurs, the water wave fluctuation will form a state illustrated in 2) or 3) in FIG. 2 and FIG. 3, in which state 2) indicates that the water surface floating body obliquely fluctuates up and down, and state 3) indicates that the water surface floating body fluctuates up and down. In the three states, generated signal differences correspond to the three states illustrated in FIG. 4.

In FIG. 4, state 1) indicates that at this time, the water surface floating body is upright and no water wave fluctuation occurs, so the two groups of infrared detection sensors (realized by B and C respectively) can obtain the transmitted signals. In state 2) of FIG. 4, due to the obliquing of the water surface floating body, the transverse and longitudinal infrared detection cannot be realized, and the two groups of infrared detection sensors cannot receive the signals. In state 3), although no obliquing occurs, the water waves fluctuate up and down, so that the transverse infrared detection (realized by C) cannot be realized and thus no signal can be received. Through the change of the signal, the hunger degree of the fish school can be known, so as to control the start or stop of the fish feeder.

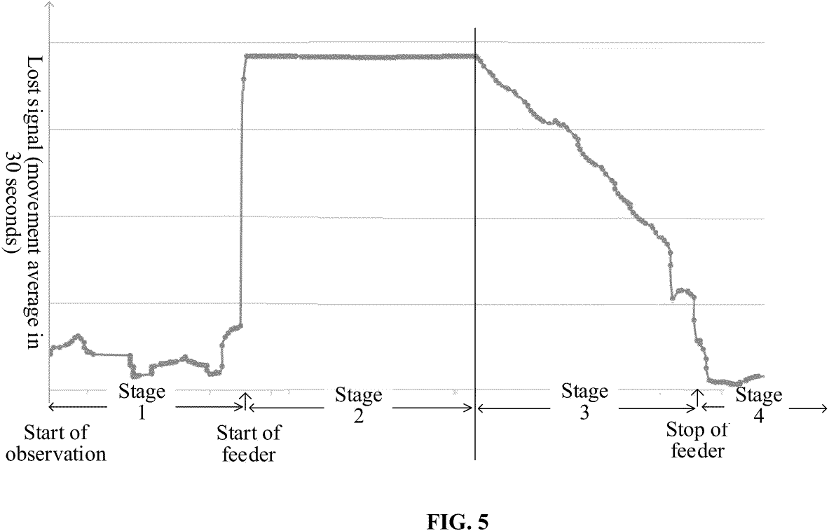

Referring to FIG. 5, the experimental application of the method according to the embodiment of the disclosure is carried out in a fishing ground. According to the method illustrated in FIG. 1, the equipment is arranged in a pond with grass carps as the culture objects. The fish feeder adopts automatic feeding. The power supply of the fish feeder is controlled by the single-chip microcomputer (i.e., the single-chip microcomputer receiving controller) H in FIG. 1. The equipment is placed in a feed feeding area through a fixing rod.

In the whole process of implementing the embodiment, the frequency of collecting transverse and longitudinal infrared signals once per second is adopted. Preferably, a 30 second movement window is adopted to calculate the water wave fluctuation, that is, 30 second movement average is adopted when whether to stop the feeder is calculated.

Before starting the fish feeder (stage 1), the fish school does not scramble for food, and only a few jump out of the water. Every 30 seconds, a large number of transverse and longitudinal signals can be detected, and only a small number of infrared signals are lost. At this time, the lost signal rate (i.e., γ= 1 - number of signals received / number of signals transmitted * 100%) is used as a reference value for feeder control in subsequent stages.

When the fish feeder is started, the fish school has obvious feeding behavior, splashing a large amount of water on the water surface, resulting in the obvious enhancement of water wave intensity. The water surface floating body obliques and fluctuates up and down at high frequency, resulting in a large loss of transverse and longitudinal signals. The signals can be detected less than 10 times every 30 seconds (stage 2). At this time, the signal loss rate is much higher than γ.

With the continuous increase of feed amount, the willingness of feeding behavior of the fish school decreases, and the frequency of transverse and longitudinal fluctuation of the water surface floating body decreases and reaches an average of 15 times or more every 30 seconds, but it still belongs to the feeding window (stage 3). At this time, the signal loss rate is still higher than γ quite a lot.

When the feed feeding lasts for 25 minutes, the fish school are full, that is, they no longer scramble for food, the water surface is calm, the water surface floating body returns to the position state before feeding, and the signal is captured more than 25 times every 30 seconds. At this time, the signal loss rate is close to γ, the single-chip microcomputer sends a signal to stop feed feeding, and the feeder is stopped (stage 4).

The specific embodiments described herein are merely used for exemplarily describing the spirit of the disclosure. Those skilled in the technical field of the disclosure can make various modifications or supplements to the described specific embodiments or replace them in a similar way, but they will not deviate from the spirit of the present application or go beyond the scope defined by the appended claims.

What is claimed is:

1. A method for detecting fish school hunger degree based on feeding behavior, the method comprising: detecting a water wave fluctuation driven by the feeding of a fish school using a water surface floating body; controlling a fish feeder by calculating water wave fluctuation intensity, the water wave fluctuation being detected by adopting a detection device associated with the water surface floating body.

2. The method of claim 1, wherein to detect the movement of the water surface floating body, an infrared detection device or other methods capable of detecting a frequency or amplitude of the movement of the water surface floating body are adopted.

3. The method of claim 2, wherein the infrared detection device comprises an infrared radiation tube and a retro-reflective sensor;
a transmitting end and a receiving end of the infrared radiation tube are disposed perpendicular to a horizontal plane; after the transmitting end of the infrared radiation tube transmits an infrared signal, if no oblique fluctuation occurs, the infrared signal is capable of being received by the corresponding receiving end, and if an oblique displacement occurs, the infrared signal is not capable of being received by the corresponding receiving end; and
the retro-reflective sensor comprises a signal transmitting/receiving end and a signal reflector; the signal transmitting/receiving end and the signal reflector are disposed parallel to the horizontal plane; after the signal transmitting/receiving end of the retro-reflective sensor transmits an infrared signal, if no upward and downward fluctuation occurs, the infrared signal is capable of being reflected back by the signal reflector and received, and if an upward and down displacement occurs, the infrared signal is not capable of being reflected back and no signal is capable of being received.

4. The method of claim 3, wherein a signal transmitting end fixing rod is disposed to connect the water surface floating body, the receiving end of the infrared radiation tube and the signal transmitting/receiving end of the retro-reflective sensor; the water surface floating body is connected to a bottom of the signal transmitting end fixing rod, the receiving end of the infrared radiation tube is disposed at a top of the signal transmitting end fixing rod, and the signal transmitting/receiving end of the retro-reflective sensor is disposed at a middle position of the signal transmitting end fixing rod.

5. The method of claim 4, wherein a single-chip microcomputer is disposed to receive detection results of the infrared radiation tube and the retro-reflective sensor, and calculate the water wave fluctuation intensity.

6. The method of claim 4, wherein the water wave fluctuation is calculated through a movement average value or maximum value of a preset time window.

7. The method of claim 4, wherein the water surface floating body is made of plastic foam or floating materials.

8. The method of claim 4, wherein the water surface floating body has a shape of a sphere, an ellipsoid or a flat plate and has a circular vertical projection on a water surface from top to bottom.

9. A system for detecting fish school hunger degree based on feeding behavior, wherein the system is used for realizing the method for detecting fish school hunger degree based on feeding behavior according to claim 1.

10. The system of claim 9, comprising a power supply battery, an infrared radiation tube, a retro-reflective sensor, a water surface floating body, a signal transmitting end fixing rod, a protection cover, a cover fixing support, and a single-chip microcomputer, wherein:
the power supply battery supplies power to the infrared radiation tube, the retro-reflective sensor and the single-chip microcomputer;
a transmitting end and a receiving end of the infrared radiation tube are disposed perpendicular to a horizontal plane; after the transmitting end of the infrared radiation tube transmits an infrared signal, if no oblique fluctuation occurs, the infrared signal is capable of being received by the corresponding receiving end, and if an oblique displacement occurs, the infrared signal is not capable of being received by the corresponding receiving end; and
the retro-reflective sensor comprises a signal transmitting/receiving end and a signal reflector; the signal transmitting/receiving end and the signal reflector are disposed parallel to the horizontal plane; after the signal transmitting/receiving end of the retro-reflective sensor transmits an infrared signal, if no upward and downward fluctuation occurs, the infrared signal is capable of being reflected back by the signal reflector and received, and if an upward and down displacement occurs, the infrared signal is not capable of being reflected back and no signal is capable of being received;
the signal transmitting end fixing rod is connected to the water surface floating body, the receiving end of the infrared radiation tube and the signal transmitting/receiving end of the retro-reflective sensor; the water surface floating body is connected to a bottom of the signal transmitting end fixing rod, the receiving end of the infrared radiation tube is disposed at a top of the signal transmitting end fixing rod, and the signal transmitting/receiving end of the retro-reflective sensor is disposed at a middle position of the signal transmitting end fixing rod;
the protection cover is disposed vertically, a bottom end of the protection cover is even with the horizontal plane, the cover fixing support is connected to the protection cover, and the single-chip microcomputer receives signals of the infrared radiation tube and the retro-reflective sensor, calculates a water wave change frequency of the water surface floating body, determines an activity of the feeding behavior of the fish school according to the frequency, and sends an instruction of feeding continuation or feeding stopping to the fish feeder.
